(19) United States
(12) Patent Application Publication
(10) Pub. No.: US 2003/0188070 A1
(43) Pub. Date: Oct. 2, 2003

(54) Method and apparatus for detecting I/O timeouts

(76) Inventor: William P. Delaney, Wichita, KS (US)

Correspondence Address: LSI Logic Corporation, Corporate Legal Department, Intellectual Property Services Group, 1551 McCarthy Boulevard, M/S D-106, Milpitas, CA, 95035, US

(21) Appl. No.: 10/113,770

(22) Filed: Apr. 1, 2002

(51) Int. Cl. G06F 13/14

(52) U.S. Cl. 710/305

(57) ABSTRACT

The I/O protocol is modified to reduce the complexity of the error recovery process. Rather than requiring the initiator to submit secondary queries to determine the status of an ongoing I/O request, the target device simply delivers periodic “interim replies” without solicitation from the initiator. The time between these replies may vary, based on higher-level configuration actions or simple implied agreement between the initiator and target. The period need only be small enough to ensure that the initiator does not time out the I/O request. These unsolicited replies are delivered within the same context as the I/O request itself, and require no independent interaction context. On the initiator side, a simple timeout timer can be triggered as soon as the initial I/O request is delivered to the target. If this timer ever expires, the initiator will take its normal, and potentially drastic, recovery actions. However, the receipt of an interim reply from the target causes the initiator to reset its timeout timer. Consequently, a long-running I/O operation may require that many interim replies be sent from the target to the initiator. Each such reply causes the timeout timer to be reset, thus avoiding an unwarranted timeout.

### BACKGROUND OF THE INVENTION

1. Technical Field

The present invention relates to data processing and, in particular, to timeout mechanisms in I/O devices. Still more particularly, the present invention provides an improved method and apparatus for detecting I/O timeouts.

2. Description of the Related Art

In a standard implementation, an initiator of an input/output (I/O) request will submit the I/O request to a target device using a protocol, such as Small Computer Systems Interface (SCSI) or Fibre Channel Protocol (FCP), then simply wait for some fixed time period to elapse or for an I/O response indication to be received. If no response arrives within the fixed time period, the initiator will generally consider the target device to be inoperative.

A typical response by the initiator is to reset the target device and retry the I/O transaction, or perhaps to retry the I/O transaction using an alternative path/route to the target if such an alternative exists. In either case, the initiator's action tends to be rather drastic. Since the initiator has received no response from the target, the initiator must take action to ensure that the target discontinues any residual processing before a retry is attempted. Failure to do so would generally result in an I/O conflict when the retry request is submitted along with an active original request.

The drastic nature of the initiator's action is warranted in cases where the target is truly malfunctioning. However, if the target is merely overloaded, or the I/O request itself simply requires a long time to process, drastic actions by an initiator will only exacerbate the problem.

One option that can improve the situation is to provide some form of intermediate status from the target, indicating that it is making progress on the request, even though it may be taking longer than the initiator expects. In a Fibre Channel environment, there are link-level primitives that allow this sort of intermediate status to be acquired by an initiator. These are the Read Exchange Status (RES) and Read Exchange Concise (REC) primitives. An initiator can optionally use these primitives to inquire on the status of an I/O request after an initial timeout period has expired, and thus determine if the target device is still operational and working on the request.

However, the drawback of these services is that they must be invoked outside the context of the I/O request in question. That is, they are treated as secondary interactions between the initiator and the target, and these secondary queries must carry an identification of the I/O request that is being queried. This adds complexity to the error recovery process. Not only must the recovery agent initiate a secondary request/response channel for the status query, but it must also deal with the potential for overlapped responses, where the actual I/O response arrives prior to the response for the query request.

Therefore, it would be advantageous to provide an improved method and apparatus for detecting I/O timeouts.

### SUMMARY OF THE INVENTION

The present invention uses a modification of the I/O protocol to reduce the complexity of the error recovery process. Rather than requiring the initiator to submit secondary queries to determine the status of an ongoing I/O request, the target device simply delivers periodic “interim replies” without solicitation from the initiator. The time between these replies may vary, based on higher-level configuration actions or simple implied agreement between the initiator and target. The period need only be small enough to ensure that the initiator does not time out the I/O request. These unsolicited replies are delivered within the same context as the I/O request itself, and require no independent interaction context.

On the initiator side, a simple timeout timer can be triggered as soon as the initial I/O request is delivered to the target. If this timer ever expires, the initiator will take its normal, and potentially drastic, recovery actions. However, the receipt of an interim reply from the target causes the initiator to reset its timeout timer. Consequently, a long-running I/O operation may require that many interim replies be sent from the target to the initiator. Each such reply causes the timeout timer to be reset, thus avoiding an unwarranted timeout.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIGS. 1A and 1B are block diagrams of exemplary data processing systems in accordance with a preferred embodiment of the present invention;

FIG. 2 is a data flow diagram illustrating Small Computer Systems Interface (SCSI) Fibre Channel Protocol (FCP) in accordance with a preferred embodiment of the present invention;

FIG. 3 is a data flow diagram that depicts an example of communication between an initiator and a target in an I/O transaction in accordance with a preferred embodiment of the present invention;

FIG. 4 is a flowchart illustrating the operation of a target of an I/O request in accordance with a preferred embodiment of the present invention; and

FIG. 5 is a flowchart illustrating the operation of an initiator of an I/O request in accordance with a preferred embodiment of the present invention.

### DETAILED DESCRIPTION

The description of the preferred embodiment of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention in a practical application to enable others of ordinary skill in the art to understand the invention for various embodiments with various modifications as are suited to the particular use contemplated.

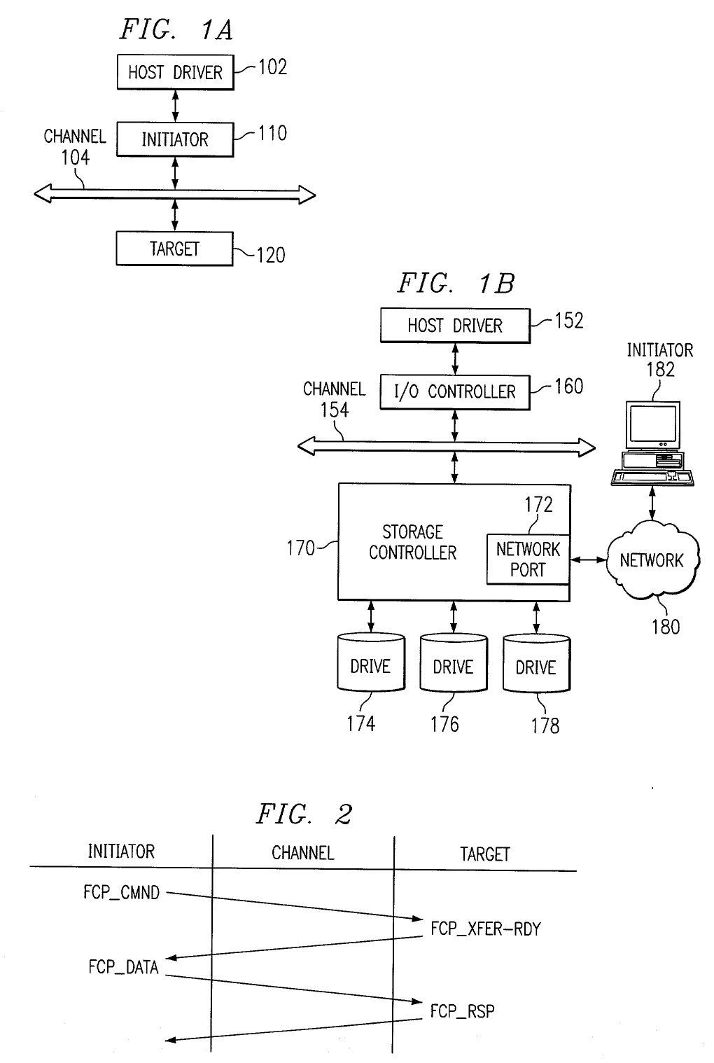

With reference now to the figures and in particular with reference to FIG. 1A, a block diagram of a data processing system is shown in accordance with a preferred embodiment of the present invention. Initiator 110 receives I/O requests from host driver 102 and initiates I/O operations on channel 104. Host driver 102 may be any driver that requests I/O operations on initiator 110. In a preferred embodiment, the host driver is a software device driver running in an instance of the operating system of a server. The initiator may be any data transfer device, such as a Small Computer Systems Interface (SCSI), Infiniband, Fibre Channel, or Serial Advanced Technology Attachment (ATA) controller.

I/O requests are sent from initiator 110 to target 120 via channel 104. The channel may be any communications channel, such as SCSI, Infiniband, or Fibre Channel. Alternatively, channel 104 may be a bus, such as a Peripheral Component Interconnect (PCI) bus, an Industry Standard Architecture (ISA) bus, or universal serial bus (USB). Target 120 may be a drive or a storage controller. For example, an Integrated Drive Electronics (IDE) hard disk drive has an integrated storage controller and may be a target. Another example of a target may be a Redundant Array of Independent Disks (RAID) storage controller.

In a preferred embodiment of the present invention, the target may be configured to deliver periodic interim replies for each outstanding I/O without solicitation from the initiator. This may be accomplished by starting a timer when the I/O is received. Each time the timer expires, an interim reply may be generated and the timer may be reset periodically until the I/O transaction is complete.

On the initiator side, a simple timeout timer can be triggered as soon as the initial I/O request is delivered to the target. If this timer ever expires, the initiator will take its normal, and potentially drastic, recovery actions. However, the receipt of an interim reply from the target causes the initiator to reset its timeout timer. Consequently, a long-running I/O operation may require that many interim replies be sent from the target to the initiator. Each such reply causes the timeout timer to be reset, thus avoiding an unwarranted timeout.

FIG. 1B illustrates a more specific example of a data processing system in accordance with a preferred embodiment of the present invention. Controller 160 receives I/O requests from host driver 152 and initiates I/O operations on channel 154. Host driver 152 may be any driver that requests I/O operations on controller 160. In a preferred embodiment, the host driver is a software device driver running in an instance of the operating system of a server. The controller may be any data transfer device, such as a Small Computer Systems Interface (SCSI), Infiniband, Fibre Channel, or Serial Advanced Technology Attachment (ATA) controller.

I/O requests are sent from I/O controller 160 to storage controller 170 via channel 154. The channel may be any communications channel, such as SCSI, Infiniband, or Fibre Channel. In a preferred embodiment storage controller 170 may be a RAID storage controller that stores data on and retrieves data from drives 174, 176, 178. In the example shown in FIG. 1B, I/O controller 160 is an initiator of an I/O transaction and storage controller 170 is the target.

Storage controller 170 may also include network port 172 that allows the storage controller to receive I/O transactions from network 180. The network may be a communications network using a network protocol, such as Transmissions Control Protocol/Internet Protocol (TCP/IP) or Internetwork Packet EXchange (IPX). Network 180 may be a Local Area Network (LAN), such as Ethernet, or a Wide Area Network (WAN), such as the Internet. Thus, storage controller 170 may receive I/O transactions from a computer, such as initiator 182, through network 180. The storage controller may be configured to send interim replies to I/O controller 160 or initiator 182 to prevent unwanted timeouts by the initiator.

With reference to FIG. 2, a data flow diagram illustrating Small Computer Systems Interface (SCSI) Fibre Channel Protocol (FCP) is shown in accordance with a preferred embodiment of the present invention. An initiator sends a command message, “FCP_CMND,”to a target to initiate an I/O transaction. “FCP_CMND” is a message containing a command that the initiator is requesting. For example, the command may initiate a read, write, format, etc.

The target may then send a transfer ready message, “FCP_XFER-RDY,” back to the initiator. The “FCP_XFER-RDY” message indicates that the target is ready to receive some amount of data from the initiator. When the target is ready, the initiator may send a data message, “FCP_DATA,” with actual data from the initiator, as when a write operation is being performed to a target device. The pair of “FCP_XFER-RDY” and “FCP_DATA” message exchanges may be repeated many times for cases where there is a large amount of data to be transferred from the initiator to the target for a given command.

When the I/O transaction is complete, the target sends a response message, “FCP_RSP,” to the initiator. The “FCP_RSP” message includes a final response and status from the target. The initiator may set a timer and determine whether the transaction has timed out if the timer expires. Each time an “FCP_XFER-RDY” message is received, the initiator may reset the timer. However, if the timer expires before an “FCP_XFER-RDY” message is received or an “FCP_RSP” message indicates completion of the transaction, the initiator may take an action to rectify the situation.

In accordance with a preferred embodiment of the present invention, the SCSI-FCP protocol may be modified to allow the target to send interim replies to the initiator without solicitation from the initiator. For example, an “FCP_XFER-RDY” message may be sent as an interim reply. The “FCP_XFER-RDY” message may indicate that the target is ready for zero data. The initiator may interpret such a message as an interim reply. Alternatively, a new type of message may be introduced, such as an interim reply message, “FCP_INT-RPLY.” Other modifications to the Fibre Channel Protocol or other protocols may also be made within the scope of the present invention.

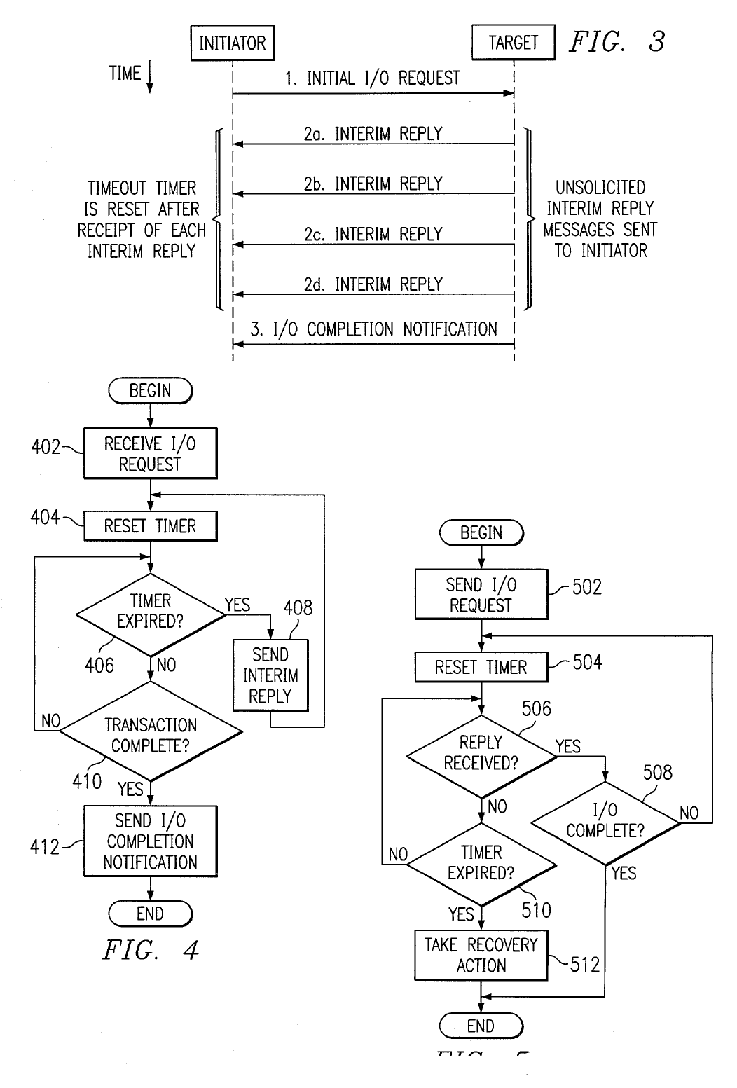

With reference now to FIG. 3, a data flow diagram depicts an example of communication between an initiator and a target in an I/O transaction in accordance with a preferred embodiment of the present invention. An initiator begins an I/O transaction by sending an initial I/O request to the target (step 1). The messages in FIG. 3 may comply with the protocol shown in FIG. 2. For example, the initial I/O request in step 1 may be an “FCP_CMND.” However, other protocols may also be used. The target receives the request, begins processing the request, and starts an internal timer. When the timer expires, the target confirms that the I/O request is being processed, sends an interim reply to the initiator (step 2a), and resets the timer.

The timer may expire several times while the target is processing the request. Therefore, several interim replies may be sent to the initiator (steps 2a-2d) before the I/O request is completed by the target. The timeout timer of the initiator is reset after receipt of each interim reply. When the target completes processing of the I/O request, the target sends an I/O completion notification to the initiator (step 3). Since the initiator receives interim replies and resets the timeout timer, any “false alarm” conditions are prevented before the I/O completion notification is received.

With reference to FIG. 4, a flowchart illustrating the operation of a target of an I/O request is shown in accordance with a preferred embodiment of the present invention. The process begins and receives an I/O request from an initiator of an I/O transaction (step 402). The process resets a timer for the I/O request (step 404). Next, a determination is made as to whether the timer is expired (step 406). If the timer is expired, the process sends in interim reply to the initiator (step 408) and returns to step 404 to reset the timer.

If the timer is not expired in step 406, a determination is made as to whether the transaction is complete (step 410). If the transaction is not complete, the process returns to step 406 to determine whether the timer is expired. If the transaction is complete in step 410, the process sends an I/O completion notification to the initiator (step 412) and ends.

Turning now to FIG. 5, a flowchart illustrating the operation of an initiator of an I/O request is shown in accordance with a preferred embodiment of the present invention. The process begins and sends an I/O request to the target of the I/O transaction (step 502). Next, the process resets a timeout timer (step 504). A determination is made as to whether a reply is received from the target (step 506). If a reply is received, a determination is made as to whether the reply is an I/O completion notification (step 508). If the reply is not an I/O completion notification, the process returns to step 504 to reset the timer. If the reply is an I/O completion notification in step 508, the process ends.

Returning to step 506, if a reply is not received, a determination is made as to whether the timeout timer is expired (step 510). If the timer is not expired, the process returns to step 506 to determine whether a reply is received from the target. If the timer is expired in step 510, the process takes an appropriate recovery action (step 512) and ends.

Thus, the present invention solves the disadvantages of the prior art by modifying the I/O protocol to reduce the complexity of the error recovery process. Rather than requiring the initiator to submit secondary queries to determine the status of an ongoing I/O request, the target device simply delivers periodic interim replies without solicitation from the initiator. An added benefit of this approach is that the general timeout threshold used by the initiator can be set to a fairly small value so that it expires shortly after detection of one or more missing interim reply messages from the target. This allows timely response to an inoperative target, as opposed to prior art solutions that required timeout values to be set fairly high to prevent “false alarm” conditions and the undesirable consequences associated with them.

While the present invention is described in the context of I/O processing, it could easily be used in the more general sense for any network-based protocol involving request/reply exchanges between an initiator and a target, a client and a server, etc.

It is important to note that while the present invention has been described in the context of a fully functioning data processing system, those of ordinary skill in the art will appreciate that the processes of the present invention are capable of being distributed in a form of a computer readable medium of instructions and in a variety of forms. Further, the present invention applies equally regardless of the particular type of signal bearing media actually used to carry out the distribution. Examples of computer readable media include recordable-type media such a floppy disc, a hard disk drive, a RAM, a CD-ROM, a DVD-ROM, and transmission-type media such as digital and analog communications links, wired or wireless communications links using transmission forms such as, for example, radio frequency and light wave transmissions. The computer readable media may take the form coded formats that are decoded for actual use in a particular data processing system.

What is claimed is:

1. A method, in a target of a transaction, for preventing premature timeouts, comprising:
a) receiving a request from an initiator of a transaction; and
b) periodically sending an interim reply to the initiator until the transaction is completed.

2. The method of claim 1, wherein the step of periodically sending an interim reply comprises:
b1) in response to receiving the request from an initiator of a transaction, starting a timer;
b2) determining whether the timer is expired;
b3) if the timer is expired, sending the interim reply to the initiator; and
b4) repeating steps (b2) and (b3) until the transaction is completed.

3. The method of claim 1, wherein the target comprises one of a hard disk drive and a storage controller.

4. The method of claim 1, wherein the initiator comprises one of an input/output controller and a computer.

5. The method of claim 1, wherein the interim reply is a transfer ready message.

6. The method of claim 5, wherein the transfer ready message is a Fibre Channel Protocol message.

7. The method of claim 6, wherein the transfer ready message indicates that the target is ready for zero data.

8. The method of claim 1, wherein the interim reply is an interim reply Fibre Channel Protocol message.

9. A method, in an initiator, for preventing premature timeouts, comprising:
a) sending a transaction request to a target of a transaction;
b) setting a timeout timer;
c) determining if an interim reply is received from the target;
d) if an interim reply is received, resetting the timeout timer; and
e) repeating steps (c) and (d) until the transaction is completed.

10. The method of claim 9, wherein the target comprises one of a hard disk drive and a storage controller.

11. The method of claim 9, wherein the initiator comprises one of an input/output controller and a computer.

12. The method of claim 9, wherein the interim reply is a transfer ready message.

13. The method of claim 12, wherein the transfer ready message is a Fibre Channel Protocol message.

14. The method of claim 13, wherein the transfer ready message indicates that the target is ready for zero data.

15. The method of claim 9, wherein the interim reply is an interim reply Fibre Channel Protocol message.

16. An apparatus, in a target of a transaction, for preventing premature timeouts, comprising:
receipt means for receiving a transaction request from an initiator of a transaction; and
reply means for periodically sending an interim reply to the initiator until the transaction is completed.

17. The apparatus of claim 16, wherein the target comprises one of a hard disk drive and a storage controller.

18. The apparatus of claim 16, wherein the initiator comprises one of an input/output controller and a computer.

19. The apparatus of claim 16, wherein the interim reply is a transfer ready message.

20. The apparatus of claim 19, wherein the transfer ready message is a Fibre Channel Protocol message.

21. The apparatus of claim 20, wherein the transfer ready message indicates that the target is ready for zero data.

22. The apparatus of claim 16, wherein the interim reply is an interim reply Fibre Channel Protocol message.

23. A storage system comprising:
an input/output controller; and
a storage controller, coupled to the input/output controller, wherein the storage controller receives a transaction request from the input/output controller and periodically sends an interim reply to the input/output controller until the transaction is completed.

24. The storage system of claim 23, wherein the storage controller is coupled to the input/output controller via a channel.

25. The storage system of claim 23, wherein the storage controller is integrated into a hard disk drive.

26. The storage system of claim 23, wherein the storage controller is one of a Small Computer Systems Interface controller, an Infiniband controller, a Fibre Channel controller, and a Serial Advanced Technology Attachment controller.

27. The storage system of claim 23, wherein the storage controller is a Redundant Array of Independent Disks controller.

28. A system comprising:
a computer;
a network; and
a storage controller, coupled to the computer via the network, wherein the storage controller receives a transaction request from the computer and periodically sends an interim reply to the computer until the transaction is completed.

29. The system of claim 28, wherein the storage controller includes a network port.

30. The system of 28, wherein the storage controller is a Redundant Array of Independent Disks controller.

31. A computer program product, in a computer readable medium, for preventing premature timeouts, comprising:
instructions for receiving a request from an initiator of a transaction; and
instructions for periodically sending an interim reply to the initiator until the transaction is completed.
